(19) United States
(12) Patent Application Publication
(10) Pub. No.: US 2026/0081247 A1
(43) Pub. Date: Mar. 19, 2026

(54) PROCESS FOR RECYCLING ALUMINUM HYDROXIDE FROM A BLACK MASS

(71) Applicant: BASF SE, Ludwigshafen Am Rhein (DE)

(72) Inventors: Wolfgang ROHDE, Ludwigshafen (DE); Tobias ELWERT, Clausthal-Zellerfeld (DE); Karl Bernhard FRIEDRICH, Aachen (DE); Christian DERTMANN, Aachen (DE)

(21) Appl. No.: 19/108,599

(22) PCT Filed: Sep. 26, 2023
(86) PCT No.: PCT/EP2023/076522

§ 371 Date: Mar. 4, 2025

(30) Foreign Application Priority Data
Sep. 28, 2022 (EP) 22198386.9

(51) Int. Cl. H01M 10/54; C22B 3/22; C22B 3/44; C22B 7/00; C22B 21/00

(52) U.S. Cl. CPC H01M 10/54; C22B 3/22; C22B 3/44; C22B 7/007; C22B 21/0023

(57) ABSTRACT

Disclosed herein is a process for recycling aluminum hydroxide from a black mass including aluminum, the process including in the given order the steps of leaching in a first leaching step the black mass in an aqueous acid solution; separating the first leaching residue from the first leaching solution; adding in a pH-adjusting step a first aqueous base solution to the first leaching solution; precipitating an Al/Fe precipitate from the first pH-adjusted leaching solution; separating the Al/Fe precipitate from the first pH-adjusted leaching solution; leaching the Al/Fe precipitate in a second aqueous base solution; separating the second leaching residue from the second leaching solution; precipitating in an Al precipitation step an Al precipitate from the second leaching solution; and separating the Al precipitate from the second leaching solution.

The project leading to this application has received funding from Bundesministerium for Wirtschaft und Klimaschutz (DE; FKZ:16BZF101A); the applicant bears responsibility for all disclosures herein.

### TECHNICAL FIELD

The present invention is concerned with a process for recycling aluminum hydroxide from battery material, in particular lithium battery material. Furthermore, the present invention is concerned with aluminum hydroxide obtainable by such a process.

### BACKGROUND

Storing electrical energy is a subject of growing interest. Efficient storage of electric energy would allow electric energy to be generated when it is advantageous and used when and where needed. Secondary electrochemical cells are well suited for this purpose due to their rechargeability. Hence, lithium-ion batteries are of special interest for energy storage since they provide high energy density due to the small atomic weight and the large ionization energy of lithium, and they have become widely used as a power source for many portable electronics such as cellular phones, laptop computers, mini-cameras, etc. but also for electric vehicles.

Lifetime of batteries, especially lithium-ion batteries, is not unlimited. It is to be expected, therefore, that a growing number of spent batteries will emerge. Since they contain important transition metals such as, but not limited to cobalt, nickel, lithium, and, in addition, aluminum, spent batteries may form a valuable source of raw materials for a new generation of batteries. For that reason, increased research work has been performed with the goal of recycling transition metals—and, optionally, even aluminum—from used lithium-ion batteries.

Furthermore, recent developments on the world market have significantly increased the prices for important raw materials for battery production. Moreover, on Mar. 17, 2022, EU environment ministers unanimously adopted the council position on the EU batteries regulation. It is foreseeable that such a regulation will afford certain recycling rates for batteries as well as recycling yields for metals used in such. Furthermore, such regulation will most likely afford that at least a certain amount of the components used in the production of such a battery in the EU will afford that also the components were made in the EU. As there are no significant resource deposits of the needed components in the EU, recycling will be the only way to produce such components within the EU. Hence, the need for a sustainable, efficient and at best well integrated process for recycling of components of batteries, in particular lithium batteries, is needed.

The cathode as used in lithium batteries generally comprises a significant amount of aluminum as carrier foil for the cathode active material. Some cathode active material contain aluminum as well namely the nickel cobalt aluminum oxide materials (NCA). As such, it is a need to provide a process as set out above leading to the recovery of metallic aluminum from battery material.

Lithium-ion batteries or parts of lithium-ion batteries that do not meet the specifications and requirements, so-called off-spec materials and production waste, may as well be a source of raw materials.

Two main processes have been subject to raw material recovery. One main process is based upon smelting of the corresponding battery scrap followed by hydrometallurgical processing of the metallic alloy or matte obtained from the smelting process. In such processes aluminum will end up in the slag from which it can be difficult to extract and recover, depending on the slag system and process.

The other main process is the direct hydrometallurgical processing of battery scrap materials. Principles have been disclosed in WO 2017/091562 and in J. Power Sources, 2014, 262, 255 ff. Such hydrometallurgical processes will furnish transition metals as aqueous solutions or in precipitated form, for example as hydroxides, separately (DE-A-19842658), or already in the desired stoichiometries for making a new cathode active material, as proposed by Demidov et al., Ru. J. of Applied chemistry 78, 356 (2005). In the latter case the composition of metal salt solutions may be adjusted to the desired stoichiometries by addition of single metal components.

Hydrometallurgical processes for precipitating transition metals like nickel and cobalt from solutions by reduction generally are known; A. R. Burkin, Powder Metallurgy 12, 243 (1969), describes a kinetic preference towards nickel precipitation. Such processes also include addition of certain nucleating agents (GB-A-740797).

WO 2022/042228 A1 describes the process of recycling aluminum carbonate from a pyrolyzed black mass originating from a lithium battery. In this process, the black mass is leached in sulfuric acid, iron powder is added to precipitate copper, the pH is increased in a step-wise manner, whereas first Goethit, α-FeO(OH) [1310-14-1], is precipitated and thereafter an iron-aluminum precipitate. Said iron-aluminum precipitate is separated and leached in a sodium hydroxide solution at 90° C. for 3 h, filtered, and the filtrate containing metaaluminate and alkali is collected. The filtrate is treated with carbon dioxide at 30° C. until the pH reached 10. Aluminum hydroxide is precipitated and filtered off the filtrate. The process of WO 2022/042228 A1, however, has the disadvantage that a certain amount of carbonates is formed, which is introduced into the precipitate. As disclosed i.e. in D. Marinos et al. Crystals, 2021, 11, 836, such carbonates can include the presence of dawsonite ([NaAl(OH)₂CO₃]), which is generally not favorable. It has also been described that aluminum hydroxide precipitated by carbon dioxide has an inferior morphology with higher amounts of fines and broad particle size distribution compared to the “sandy” one obtained from the Bayer process which renders this material less suited for the melt electrolysis process to produce metallic aluminum (Hydrometallurgy 98, 52).

U.S. Pat. No. 3,120,996 is aware of the problem of sodium carbonate impurities in the Bayer process. As a solution U.S. Pat. No. 3,120,996 discusses addition of slaked lime causing the formation of calcium carbonate as a precipitate and sodium hydroxide. However, this solution has the disadvantage of adding a separate process step and, hence, complexity. Furthermore, slaked lime consumption of the process is also increased.

### SUMMARY OF THE INVENTION

Hence, there is the need for a process, which allows for efficient aluminum hydroxide recovery from lithium battery derived material, which does not produce carbonates and produces a “sandy” aluminum hydroxide best suited for the melt electrolysis to produce metallic aluminum.

It is therefore an object of the present invention to provide an efficient process for recycling aluminum hydroxide from a battery material, which in particular does not lead to the formation of carbonates in the aluminum hydroxide comprising precipitate and produces an aluminum hydroxide best suited for the melt electrolysis to produce metallic aluminum.

It has now been surprisingly found that above-mentioned object can be achieved by a process for recycling aluminum hydroxide from a black mass comprising aluminum, the process comprising in the given order the steps of
leaching in a first leaching step the black mass in an aqueous acid solution, thereby producing a first leaching solution and a first leaching residue;
separating in a first separation step the first leaching residue from the first leaching solution;
adding in a pH-adjusting step a first aqueous base solution to the first leaching solution, thereby pH-adjusting the first leaching solution yielding a first pH-adjusted leaching solution;
precipitating in an Al/Fe precipitation step an Al/Fe precipitate from the first pH-adjusted leaching solution, wherein the Al/Fe precipitate comprises mixed aluminum-iron hydroxide and/or aluminum hydroxide;
separating in a second separation step the Al/Fe precipitate from the first pH-adjusted leaching solution;
leaching in a second leaching step the A/Fe precipitate in a second aqueous base solution, thereby producing a second leaching solution and a second leaching residue;
separating in a third separation step the second leaching residue from the second leaching solution;
precipitating in an Al precipitation step an Al precipitate from the second leaching solution, wherein the Al precipitate comprises aluminum hydroxide, and wherein no carbon dioxide or carbonate is added as a precipitation aid to the second leaching solution;
separating in a fourth separation step the Al precipitate from the second leaching solution.

As the Al precipitation step is analogous to the Al precipitation step performed in the Bayer process the Al/Fe precipitate obtained during the recycling process of batteries can be introduced into an aluminum hydroxide production plant operated according to the Bayer process. Hence, preferably, the Al/Fe precipitate of the Al/Fe precipitation step is preferably suitable for being introduced into an aluminum hydroxide production plant operated according to the Bayer process. Preferably, the process of the present invention comprises the step of introducing at least a part of the Al/Fe precipitate of the Al/Fe precipitation step into an aluminum hydroxide production plant operated according to the Bayer process.

It has been further found out that the present object can be achieved by the provision of aluminum hydroxide obtainable by a process as described above.

One advantageous effect of the invention is that during the whole process route the formation of carbonates is avoided. Such carbonates are in particular problematic in the Al precipitation step for precipitating aluminum hydroxide. Another advantageous effect of the present invention is that iron and aluminum are separated in a step subsequent to the first leaching. Hence, not only aluminum, but also iron might be recovered.

As materials obtained from hydrometallurgical processing of battery materials may contain lithium it is possible that lithium will also enter into the second leach solution and also enter into the Al precipitate. The problem of lithium impurities in aluminum hydroxide production plants operated according to the Bayer process is known in the art and separation concepts have been described (s. for example Ullmann s Encyclopedia of Industrial Chemistry—2000—Hudson—Aluminum Oxide 2012, p. 629, Han et al, Metals 2021, 11, 1148).

### BRIEF DESCRIPTION OF THE DRAWINGS

FIG. 1 shows a schematic description of the process of the present invention.

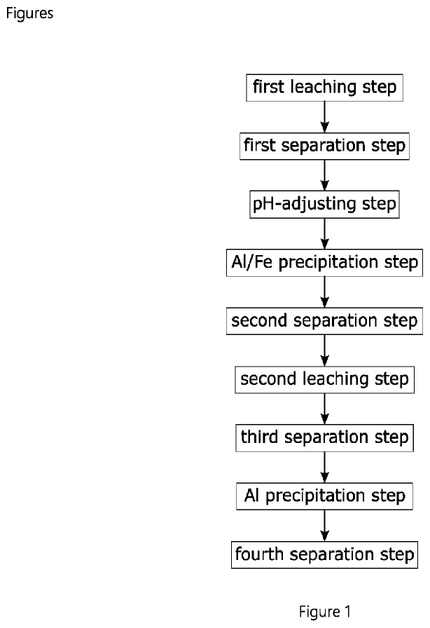

### DEFINITIONS

Before describing in detail exemplary embodiments of the present invention, definitions which are important for understanding the present invention are given.

The term “black mass” as used herein denotes the solid residue obtained by dismantling and comminuting of batteries. The black mass is obtained as fine fraction of classifying stages and comprises the active materials of the cathodes and anodes of the batteries together with some impurity particles. This black mass can either be directly treated in an hydrometallurgical process or after a pyrolysis treatment. After the pyrolysis step a lithium extraction step may follow resulting in a lithium salt solution and a lithium depleted residue which in the following is also denoted black mass.

As used in this specification and in the appended claims, the singular forms of “a” and “an” also include the respective plurals unless the context clearly dictates otherwise. In the context of the present invention, the terms “about” and “approximately” denote an interval of accuracy that a person skilled in the art will understand to still ensure the technical effect of the feature in question. The term typically indicates a deviation from the indicated numerical value of ±10%, preferably ±8%, more preferably ±5%, even more preferably ±2%. It is to be understood that the term “comprising” and “encompassing” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “i” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

As used herein the term “does not comprise”, “does not contain”, or “free of” means in the context that the composition of the present invention is free of a specific compound or group of compounds, which may be combined under a collective term, that the composition does not comprise said compound or group of compounds in an amount of more than 0.8% by weight, based on the total weight of the composition. Furthermore, it is preferred that the composition according to the present invention does not comprise said compounds or group of compounds in an amount of more than 0.5% by weight, preferably the composition does not comprise said compounds or group of compounds at all.

When referring to compositions and the weight percent of the therein comprised ingredients it is to be understood that according to the present invention the overall amount of ingredients does not exceed 100% (±1% due to rounding).

### DETAILED DESCRIPTION OF THE PRESENT INVENTION

In the process of the present invention aluminum hydroxide is recycled from a black mass comprising aluminum and/or aluminum compounds. Metallic aluminum may originate from electrode current collector foils or casings aluminum compounds that may be present in a black mass in the form of aluminum oxide, lithium nickel cobalt aluminum oxide (NCA), aluminum phosphate, lithium aluminate, and/or alumosilicates. Hence, generally, the present process could be used to recycle aluminum from any material comprising aluminum oxide, lithium nickel cobalt aluminum oxide (NCA), aluminum phosphate, lithium aluminate, and/or alumosilicates. However, it is preferred that the black mass originates from battery material, preferably a lithium battery material. In lithium-ion batteries typically the cathode foil is made from aluminum and the cathode active material may comprise aluminum. Hence, such lithium battery material typically comprises a significant amount of aluminum.

Usually, in the recycling processes for batteries, in particular lithium-ion based batteries, a pyrolysis step is involved. Such a pyrolysis step usually is a thermal pre-treatment step, in which the pre-sorted batteries or battery components are heated so that their constituent organics are decomposed. While the present invention works with any black mass, in the process according to the present invention, the black mass is preferably a pyrolyzed material, most preferably a pyrolyzed lithium battery material.

After the pre-treatment by pyrolysis, the process of the present invention can be roughly described by three process steps: a) a first leaching step, in which the black mass is first leached in an acidic environment and subsequently partially again precipitated, b) a second leaching step, in which the precipitate is leached in a basic environment, thereby separating the resulting aluminate solution from the filter residue, and c) a precipitation step (denoted herein as the ‘Al precipitation step’), in which neither carbon dioxide or any carbonate is added and which results in the formation of aluminum hydroxide.

In some processes after the pyrolysis lithium is extracted first from the black mass and afterwards the lithium depleted residue is treated in the inventive way described above starting with step a). The lithium pre-extraction can be done by treatment with water or alkaline earth oxides or hydroxides in polar solvents. There are also processes known in the art where the pyrolysis is performed in the presence of acidic salts such as sodium bisulfate. In the latter case, the lithium is subsequently extracted in form of the corresponding neutral salt e. g. lithium sulfate.

In the process according to the present invention, preferably no carbonates are formed, i.e., no carbon dioxide or any carbonate is added to any of the used solutions in the process between the first leaching step and recovery of the Al precipitate in the fourth separation step. In the Al precipitation step no carbon dioxide or carbonate is added.

Nevertheless, the process necessarily comprises more than these steps so that the process of the present invention comprises the steps of
leaching in a first leaching step the black mass in an aqueous acid solution, thereby producing a first leaching solution and a first leaching residue;
separating in a first separation step the first leaching residue from the first leaching solution;
adding in a pH-adjusting step a first aqueous base solution to the first leaching solution, thereby pH-adjusting the first leaching solution yielding a first pH-adjusted leaching solution;
precipitating in an Al/Fe precipitation step an Al/Fe precipitate from the first pH-adjusted leaching solution, wherein the Al/Fe precipitate comprises mixed aluminum-iron hydroxide and/or aluminum hydroxide;
separating in a second separation step the Al/Fe precipitate from the first pH-adjusted leaching solution;
leaching in a second leaching step the Al/Fe precipitate in a second aqueous base solution, thereby producing a second leaching solution and a second leaching residue;
separating in a third separation step the second leaching residue from the second leaching solution;
precipitating in an Al precipitation step an Al precipitate from the second leaching solution, wherein the Al precipitate comprises aluminum hydroxide, and wherein no carbon dioxide or carbonate is added as a precipitation aid to the second leaching solution;
separating in a fourth separation step an Al precipitate from the second leaching solution.

The first leaching step of the process of the present invention is used to dissolve the majority of elements including aluminum and iron. Hence, the black mass is treated with an acid, wherein in the first leaching step the acid of the aqueous acid solution is preferably selected from the list consisting of sulfuric acid, hydrochloric acid, nitric acid, citric acid, oxalic acid, and mixtures thereof. Most preferably, the acid of the aqueous acid solution is sulfuric acid, as sulfuric acid is a highly available strong acid ensuring that most of the elements in the black mass are dissolved. Furthermore, it produces environmentally unproblematic sulfates.

In order to achieve good leaching yields, in the process according to the present invention, in the first leaching step the concentration of the acid in the aqueous acid solution is preferably from 0.05 M to 5 M or from 0.1 N to 10 N. However, not only the concentration of the acid is decisive to achieve optimal leaching yields, but also the absolute molar ratio between the acid and the elements of the black mass. Hence, preferably, in the inventive process the mass ratio of the black mass to the aqueous acid solution is in the range of 10 wt % to 35 wt %, preferably of 12 wt % to 30 wt %, and most preferably from 14 wt % to 25 wt %.

To achieve best intermixing, in the inventive process the first leaching step comprises the step of stirring the aqueous acid solution. Preferably, the first leaching step, and in particular the step of stirring the aqueous acid solution, is carried out at a temperature in the range of 80° C. to 100° C. Likewise, also preferably, the first leaching step and in particular the step of stirring the aqueous acid solution are carried out for a time within the range of 30 minutes to 600 minutes. It should be understood that, depending on the conditions used in the first leaching step, in particular in view of the pH environment and redox potential, it can be adjusted, which elements will be dissolved from the black mass and which not. Usually, the carbon fraction as comprised in the black mass is not dissolved by the aqueous acid solution. Furthermore, typically, the pH environment and the redox potential are gradually varied to allow for separate dissolution of several metal fractions of the black mass.

Hence, in view of copper, the reactions conditions can be chosen to be sufficiently reductive to ensure that copper is not dissolved in the aqueous acid solution. Usually, this is achieved by excluding oxidant such as air or oxygen in the first leaching step. On the contrary, oxidative conditions can be used to ensure that copper is present in the oxidation state +2 for easier solvation. Preferably, such oxidative conditions are achieved by addition of oxidants selected from the list consisting of oxygen, air, hydrogen peroxide, dinitrogen oxide, lithium metal oxides, high valent metal oxides such as permanganates ferrates, and mixtures thereof. In cases where lithium metal oxides or higher valent metal oxides are employed any excess of these compounds may be reduced by addition of suitable reductants and optionally adaption of the pH-value of the reaction mixture. Preferably, such reductive conditions are achieved by addition of reductants like hydrogen peroxide, sulfur dioxide, sodium meta bisulfite and/or hydrogen.

However, in case copper is dissolved in the aqueous acid solution, it needs to be selectively separated from the aluminum and iron to ensure that it does not precipitate in the subsequent Al/Fe precipitation step. Hence, in one embodiment of the invention, the conditions can be chosen in that copper is not dissolved in the aqueous acid solution. In such an embodiment, the first leaching step is carried out under exclusion of an oxidant, such as air, oxygen or hydrogen peroxide and copper remains in the leached black mass, which can be subject to any other leaching process after separation from the aqueous acid solution.

However, in case it is necessary to provide also for a separation of copper in the same process, the process of the present invention preferably comprises a further copper separation step, in which copper is separated from the aqueous acid solution. Such a copper separation step could be carried out as precipitation of copper sulfide and subsequent separation e. g. filtration, solvent extraction or precipitation using ignoble metal powder (e.g. iron, nickel, cobalt, manganese of which iron is not preferred as it adds additional unwanted iron to the leach solution) and subsequent separation e. g. filtration.

After the first leaching step, the leaching residue comprising mainly carbon and optionally copper has to be separated from the leaching solution, which holds most of the elements to be recycled. Preferably, the first separation step is carried out as a separation step according to one or more of the list consisting of a filtration step, a centrifugation step, a sedimentation step and a decantation step, most preferably the first separation step is carried out as a filtration step. The leaching residue can be further processed to recover carbon and optionally copper depending on the choice made in view of solvation of copper.

The next step in the inventive process is the selective precipitation of aluminum and iron from the solution of the elements to be recovered from the black mass. This is performed by adjustment of the pH of the leaching solution. The pH value of the leaching solution is usually low e.g., in a range between 0 and 2. Hence, to assure selective precipitation of aluminum and iron, in the pH-adjusting step of the inventive process a first aqueous base solution is added to the leaching solution. For optimal precipitation conditions, the first pH-adjusted leaching solution preferably has a pH value equal to or higher than 3.5, and more preferably equal to or higher than 4. Likewise, the first pH-adjusted leaching solution preferably has a pH value equal to or lower than 7, and more preferably equal to or higher than 5, and most preferably equal to or higher than 4. To achieve ideal conditions, most preferably, in the pH-adjusting step of the process according to the present invention the first pH-adjusted leaching solution has a pH value in the range of 4.3 to 4.7. Preferably, in the pH-adjusting step the concentration of the base in the second aqueous base solution is from 3 N to 25 N.

Preferably, in the pH-adjusting step of the inventive process the base of the first aqueous base solution is selected from the list consisting of metal oxides, hydroxides or carbonates. Preferred metals in these compounds are alkali and alkali earth metals, nickel, cobalt and manganese and mixtures thereof, preferably is selected from the list consisting of sodium hydroxide, lithium hydroxide, potassium hydroxide or sodium carbonate. Ammonium hydroxide is also a suitable base and may be employed alone or in combination with said metal bases. To prevent any risk of introducing carbonate in the later Al precipitation stage, most preferably the base of the first aqueous base solution is an alkali hydroxide, most preferably sodium hydroxide.

To ensure a complete precipitation of iron in the Al/Fe precipitation it is preferred to oxidize all iron species in the solution prior to or during the pH-adjustment to ferric species. This oxidation can be achieved by introducing e. g. oxygen or air or hydrogen peroxide or dinitrogen oxide. The oxidation assures that the majority of Fe²⁺ ions present in the solution are oxidized to Fe³⁺ ions, further enhancing the separation efficiency of the separation of aluminum and iron, and is in particular useful in case the first leaching step has been carried out under reductive conditions

With the adjustment of the pH value in the pH-adjustment step, the conditions are prepared to allow for selective precipitation of aluminum and iron. Usually, the Al/Fe precipitate will precipitate after some time. However, preferably, the Al/Fe precipitation step comprises the step of stirring the first pH-adjusted leaching solution. This ensures a better homogenization of conditions such as pH and temperature. Preferably, the Al/Fe precipitation of the inventive process is carried out at a temperature in the range of 10° C. to 90° C., more preferably 18 to 90° C., even more preferably 20 to 80°, and most preferably, the Al/Fe precipitation step and in particular the step of stirring the first pH-adjusted leaching solution is carried out at room temperature. Preferably, the Al/Fe precipitation step and in particular the step of stirring the first pH-adjusted leaching solution is carried out for a time within the range of 1 h to 15 h, more preferably 2 h to 11 h, and most preferably 7 to 9 h.

To enhance precipitation yield and speed, the Al/Fe precipitation step is preferably carried out in the presence of aluminum hydroxide seeding crystals. Furthermore, to enhance separation efficiency, the Al/Fe precipitation step of precipitating the mixed aluminum/iron hydroxide and or aluminum hydroxide is preferably carried out in more than one stage, i.e. by collecting the pH-adjusted leaching solution after the second separation step and carrying out a second Al/Fe precipitation step thereon. In this second Al/Fe precipitation step it is particularly preferable to use aluminum hydroxide seeding crystals.

It should be understood that while the pH adjustment step and the Al/Fe precipitation step are in principle serially connected, they can also show a certain overlap. Hence, generally, the Al/Fe precipitation step can be invoked by the pH adjustment step. However, also other parameters can influence precipitation, such as addition of seed crystals and modification of concentrations.

Nevertheless, the pH adjustment can be carried out stepwise, thereby invoking Al/Fe precipitation in each step. Nevertheless, the serial nature of pH adjustment followed by Al/Fe precipitation is not touched by such an observation.

After finalization of the Al/Fe precipitation step, the Al/Fe precipitate comprising mixed aluminum-iron hydroxide and/or aluminum hydroxide (i.e., if only aluminum and no iron has been present in the black mass) has to be separated from the pH-adjusted leaching solution in the second separation step. In parallel to the first separation step, also the second separation step preferably is carried out as a separation step according to one or more of the list consisting of a filtration step, a sedimentation step, a centrifugation step, and a decantation step, most preferably the second separation step is carried out as a filtration step.

It should be understood that with higher pH values the co-precipitation of Ni and Co also increases. Therefore, ideally, the pH conditions in the Al/Fe precipitation step are adjusted to precipitate as little as possible Ni or Co. However, in case of possible Ni and Co entrainments into the Al/Fe precipitate it is possible to separate aluminum from the precipitate in the second leaching step, thereby obtaining a Ni/Co containing leaching residue being mainly comprised of iron hydroxide. This residue may then be re-cycled to the first leaching step or after the first leaching step prior to or during the pH-adjustment step as metal base. It is also possible to selectively separate the Ni/Co precipitate from the iron precipitate prior to this recycling e. g. by selective dissolution of the Ni/Co hydroxides in a pH range between 3.5 to 7.

To selectively separate aluminum from iron and other residual metals e. g. nickel and cobalt comprised in the Al/Fe precipitate, the Al/Fe precipitate is treated with a second aqueous base solution. Preferably, in this second leaching step of the inventive process the base of the second aqueous base solution is an alkali hydroxide or a mixture of alkali hydroxides, preferably is sodium hydroxide or potassium hydroxide. It is especially important for the present invention to prevent any risk of introducing carbonate in the precipitates. Therefore, the base of the second base aqueous solution is preferably free of any carbonates.

Preferably, also the second leaching step comprises the step of stirring the first aqueous base solution. To achieve optimal separation conditions, the second leaching step and in particular the step of stirring the first aqueous base solution is preferably carried out at a temperature in the range of 150° C. to 230° C., more preferably of 160° C. to 190° C., and most preferably of 170° C. to 180° C. Preferably, the second leaching step and in particular the step of stirring the first aqueous base solution is carried out for a time in the range of 30 minutes to 90 minutes, preferably of 40 minutes to 80 minutes, and most preferably from 50 minutes to 70 minutes.

After finalization of the second leaching step, the second leaching solution comprises most of the aluminum fraction, whereas the second leaching residue comprises most of the iron fraction. In parallel to the first and second separation steps, also the third separation step preferably is carried out as a separation step according to one or more of the list consisting of a filtration step, a sedimentation step, a centrifugation step, and a decantation step, most preferably the third separation step is carried out as a filtration step. Preferably, the filter residue, i.e. the second leaching residue, is washed and the washing fractions are recombined with the second leaching solution. The second leaching solution is used for the succeeding precipitation step, whereas the second leaching residue can be subjected to a new acidic leaching step to recover the iron. Alternatively, the second leaching residue may be subjected to a pyrometallurgical treatment to eventually recover metallic iron.

To invoke precipitation, the second leaching solution is allowed to cool down. Hence, preferably, the Al precipitation step and in particular the step of stirring the second leaching solution is carried out at a temperature below the temperature of the second leaching step, more preferably at room temperature. Furthermore, time is needed to achieve good separation efficiency. To ensure homogenous conditions in the second leaching solution, the Al precipitation step preferably comprises the step of stirring the second leaching solution. As indicated above, the time for precipitation is important. Hence, preferably, the Al precipitation step and in particular the step of stirring the second leaching solution is carried out for a time within the range of 1 h to 60 h, more preferably 2 h to 55 h, and most preferably 35 to 48 h.

To enhance the precipitation yield and speed, preferably, the process of the present invention further comprises the step of adding aluminum hydroxide seed crystals to the second leaching solution prior to the Al precipitation step. Preferably, the weight of the aluminum hydroxide seed crystals to the weight of the Al precipitate is in the range of 0.03 to 0.30, preferably 0.05 to 0.1, and most preferably 0.05 to 0.07. It is mandatory for the present invention that no carbon dioxide or carbonate is added as a precipitation aid to the second leaching solution. Preferably, no precipitation aid other than aluminum hydroxide is added to the second leaching solution

After the Al precipitation step has been completed, the Al precipitate comprising aluminum hydroxide has to be separated from the second leaching solution in the fourth separation step. In parallel to the first, second, and third separation steps, also the fourth separation step preferably is carried out as a separation step according to one or more of the list consisting of a filtration step, a sedimentation step, a centrifugation step, and a decantation step, most preferably the fourth separation step is carried out as a filtration step. Usually, the Al precipitate is washed with water. Finally, the Al precipitate is dried. The aluminum precipitation recovery rate of the second leaching step is preferably more than 19%. Furthermore, the purity of the Al precipitate, i.e., the aluminum hydroxide, is preferably more than 85%. The liquid solution still may contain aluminum and can be recycled (optionally after a concentration step) to the second leaching stage.

Finally and preferably, the inventive process comprises a refining step after the fourth separation step, wherein in the refining step the aluminum is separated from the aluminum hydroxide comprised in the Al precipitate, thereby producing metallic aluminum. Preferably, the refining step comprises a molten salt electrolysis step. Aluminum refining by molten salt electrolysis is known in the prior art since decades.

### Measurement Methods

### a) Sample Preparation for Elementary Analysis

The black mass samples were dried for analysis. Solutions were already pre-diluted in a ratio of 1 to 10 and acidified with 2.5 ml conc. HNO₃. The chemical laboratory was certified according to DIN EN ISO 9001:2015. All subsequent work steps and applications are subject to the certified range.

### b) Sample Preparation Solids

A sample of 50 mg was weighed into Teflon vessels on an analytical balance, mixed with 6 ml conc. HNO₃ and 2 ml conc. HCl. After a pre-reaction time of about 30 minutes, the vessels were sealed and placed in the high-pressure microwave “TurboWave Pro” from MLS (MLS Mikrowellen-Labor-Systeme GmbH, Leutkirchen, Germany). The samples were treated with the “charcoal” program for about 40 minutes until they dissolved without leaving any residues. After transfer into 50 ml volumetric flasks, the samples were additionally diluted in the ratios 1 to 10 and 1 to 100. At each dilution 2.5 ml conc. HNO₃ was added to the solution. Each solid sample was prepared in duplicate.

### c) Sample Preparation Solutions

The liquid samples were also diluted in ratios of 1 to 10 and 1 to 100 and acidified with concentrated nitric acid to give approximately 5% acid matrix.

### d) Measurement of Metal Cations and Phosphorus

The addressed metal concentrations were determined by inductive coupled plasma optical emission spectroscopy (ICP-OES). A device of the type “ICP-OES 5900 SVDS” from Agilent (Agilent Technologies Inc, Santa Clara, CA, USA), was used, which was purchased especially for the analysis of black mass samples. An external calibration series was prepared for the purpose based on DIN 38402-51 from certified single element standards, which were obtained from LGC. For monitoring the measurement process, a synthetic control sample of known concentration was also used to obtain a reference between the sample measurements. To prevent physical interferences, the samples and the solutions of the calibration series were adapted to the matrix of the rinsing solution (5% HNO₃). Measurement results that were above the highest calibration standard were determined from the lowest possible dilution. Values below the lowest calibration standard were indicated with the note “<detection limit”. The wavelengths of the individual elements were hand-selected by the trained user for each element so that no chemical interferences interfere with the measurement. Only in this way can a correct measurement be guaranteed.

### e) Measurement of the Carbon Content

The solid samples were inductively burnt in an oxygen stream in a device of the type “CS 2000” from the company Eltra (ELTRA GmbH, Haan, Germany). The carbon contained in the exhaust gas stream is catalytically converted to CO₂ at the platinum network and detected by means of a resistance measuring cell. Certified standard samples are used as a reference.

### f) Measurement of the Fluoride Content Solid/Liquid

The fluoride content was determined for solids and solutions using an ion-sensitive electrode (ISE) of the type Titrando (Metrohm AG, Heirsau, Switzerland). For this purpose, 2 ml of the undiluted sample was made up to 20 ml, placed in a vessel and 25 ml of TISAB IV solution was added. The concentration of the fluoride is determined via the applied voltage between the ISE and a silver reference electrode using an external calibration. Synthetic control standards are used for monitoring.

### EXAMPLES

In the following three examples are described, which illustrate the three steps of the process of the present invention finally yielding aluminum hydroxide (i.e., before the refining step).

### Example 1: Leaching

14 kg of black mass are leached in 70 liters of 6N/3M H2SO4 at 80° C. for 120 minutes. The leaching solution is filtered, the filter cake is washed and dried at 80° C. The filtrate serves further for the precipitation of the aluminum-iron hydroxide. The filter residue and the liquid sample are analyzed for Li, Al, Fe, Cu, Ni, Co, Mn, P, F and C.

For the elements listed, leaching yields up to the following can be achieved: Li 93.50%, Al 83.42%, Fe 92.05%, Cu 0.00%, Ni 45.11%, Mn 94.10%, Co 56.58%, P 93.71% and F 90.10%. All the carbon remains in the filter cake. The composition of the input material and filter residue as well as the leaching yields are given in table 1. The mass of the produced filter residue was 9244.04 kg.

TABLE 1

| | Material | | | | | | | | | |
|---|---|---|---|---|---|---|---|---|---|---|
| | Li | Al | Fe | Cu | Ni | Mn | Co | P | F | C |
| | Unit | | | | | | | | | |
| | % | % | % | % | % | ppm | % | % | % | % |
| Blackmass | 3.69 | 4.58 | 0.54 | 6.68 | 24.90 | 3200 | 5.14 | 0.40 | 1.60 | 29.20 |
| Filter | 0.39 | 1.15 | 0.07 | 10.12 | 20.70 | 286 | 3.38 | 0.04 | 0.24 | 43.80 |
| Residue | | | | | | | | | | |
| Yield | 93.50 | 83.42 | 92.05 | 0.00 | 45.11 | 94.10 | 56.58 | 93.71 | 90.10 | 0.00 |

### Example 2. Precipitation of Aluminum-Iron Hydroxide

70 liters of the leaching filtrate as produced in example 1 are used to precipitate aluminum-iron hydroxide at room temperature. Continuously, 4 l/min oxygen is injected into the solution for the oxidation of Fe²⁺ ions. A 10 M NaOH solution is used to adjust the pH until the final value of pH 4.5 is reached. At pH 4131.35 g Al(OH)₃ seed crystals are added to the solution. After the desired final pH value is reached, the solution is stirred for further nine hours. The filter residue and the liquid sample are analyzed for Li, Al, Fe, Ni, Co, Mn, P and F.

65.01 wt % of aluminum and 48.77 wt % of iron in solution can be recovered both as hydroxide by this method. Contamination of the hydroxide product by other battery-relevant elements occurs, so that a purity of 77.64% in relation to Al/Fe(OH), can be achieved. The largest impurities are nickel with up to 3.69 wt % and phosphorus with up to 2.62 wt %. The composition of the precipitate is given in table 2. The mass of the produced precipitate was 2.148 kg.

TABLE 2

| | Element | | | | | | | |
|---|---|---|---|---|---|---|---|---|
| | Li | Al | Fe | Ni | Mn | Co | P | F |
| | Unit | | | | | | | |
| | % | % | % | % | ppm | % | % | % |
| Precipitate | 1.41 | 18.30 | 1.58 | 3.69 | 361 | 0.73 | 2.62 | 1.72 |
| Yield | 5.84 | 65.01 | 48.77 | 5.04 | 1.84 | 3.85 | ≈100 | 18.31 |

### Example 3. Precipitation of Aluminum Hydroxide

200 g of the aluminum-iron hydroxide produced in example 2 are leached in 1 liter of 3N/3M NaOH solution at 175° C. in an autoclave for 60 minutes. The solution was filtered yielding a filtrate containing 17.9 g/l Al which corresponds to a Al-leaching yield of 49%. Afterwards the filtrate is stirred for 48 h at room temperature for Al(OH)₃ precipitation. 3 g Al(OH)₃ seed crystals are added to solution. The liquid samples and the precipitated product are analyzed for Li, Al, Fe, Ni, Co, Mn, P and F.

Fe, Ni, Mn and Co are below the ICP-OES detection limit of 0.5 mg/l in leaching solution and therefore remain in the filter cake. Nevertheless, about 1.87 mg of Fe and Co were detected in the final product. The aluminum in solution precipitated the resulting filtrate contained 14.4 g/l Al which is close to the calculated solubility limit at the given parameters of approx. 15 g/l. From this an aluminum precipitation recovery of 19.6% is calculated. The final aluminum hydroxide product has a purity of 85.9%. Due to the initial input material and the process, the relevant remaining impurities are Li, P and F. Table 3 represents the final products and filtrates composition. The mass of the produced precipitate was 9.33 g

TABLE 3

| | | Material | | | | | | | |
|---|---|---|---|---|---|---|---|---|---|
| | Unit | Li | Al | Fe | Ni | Mn | Co | P | F |
| Precipitate | Wt.-% | 1.21 | 29.70 | 0.02 | 0.00 | 0.00 | 0.02 | 0.38 | 0.23 |
| Filtrate | g/l | 0.00 | 14.40 | 0.00 | 0.00 | 0.00 | 0.00 | 0.61 | 0.16 |

1. A process for recycling aluminum hydroxide from a black mass comprising aluminum, the process comprising in the given order the steps of:
leaching in a first leaching step the black mass in an aqueous acid solution, thereby producing a first leaching solution and a first leaching residue;
separating in a first separation step the first leaching residue from the first leaching solution;
adding in a pH-adjusting step a first aqueous base solution to the first leaching solution, thereby pH-adjusting the first leaching solution yielding a first pH-adjusted leaching solution;
precipitating in an Al/Fe precipitation step an Al/Fe precipitate from the first pH-adjusted leaching solution, wherein the Al/Fe precipitate comprises mixed aluminum-iron hydroxide and/or aluminum hydroxide;
separating in a second separation step the Al/Fe precipitate from the first pH-adjusted leaching solution;
leaching in a second leaching step the Al/Fe precipitate in a second aqueous base solution, thereby producing a second leaching solution and a second leaching residue;
separating in a third separation step the second leaching residue from the second leaching solution;
precipitating in an Al precipitation step an Al precipitate from the second leaching solution, wherein the Al precipitate comprises aluminum hydroxide, and wherein no carbon dioxide or carbonate is added as a precipitation aid to the second leaching solution; and
separating in a fourth separation step the Al precipitate from the second leaching solution.

2. The process according to claim 1, wherein the black mass is a pyrolyzed battery material.

3. The process according to claim 1, wherein in the first leaching step, the acid of the aqueous acid solution is selected from the group consisting of sulfuric acid, hydrochloric acid, nitric acid, citric acid, oxalic acid, and mixtures thereof.

4. The process according to claim 1, wherein in the pH-adjusting step, the first pH-adjusted leaching solution has a pH value in a range of from 3.5 to 5.

5. The process according to claim 1, wherein in the pH-adjusting step, the base of the first aqueous base solution is selected from the group consisting of ammonium hydroxide, alkali hydroxides, alkali carbonates, alkali earth hydroxides, and mixtures thereof.

6. The process according to claim 1, wherein in the Al/Fe precipitation step comprises the step of stirring the first pH adjusted leaching solution, wherein the step of stirring the first pH-adjusted leaching solution is carried out at a temperature in a range of from 18 to 90° C.

7. The process according to claim 6, wherein in the Al/Fe precipitation step, the step of stirring the first pH-adjusted leaching solution is carried out for a time within a range of from 1 h to 15 h.

8. The process according to claim 1, wherein the second leaching step is carried out at a temperature in a range of from 150° C. to 230° C.

9. The process according to claim 1, wherein the pH-adjusting step and/or the Al/Fe precipitation step is carried out in the presence of an oxidant.

10. The process according to claim 9, wherein in the pH-adjusting step and/or the Al/Fe precipitation step, the oxidant comprises oxygen and is injected into the first leaching solution.

11. The process according to claim 1, wherein the Al precipitation step is carried out at a temperature below the temperature of the second leaching solution in the second leaching step.

12. The process according to claim 1, wherein the Al precipitation step is carried out for a time within a range of from 1 h to 60 h.

13. The process according to claim 1, wherein the process further comprises the step of adding aluminum hydroxide seed crystals to the second leaching solution prior to the Al precipitation step and/or prior to the Al/Fe precipitation step.

14. The process according to claim 13, wherein the ratio of the weight of the aluminum hydroxide seed crystals to the weight of the Al precipitate is in a range of from 0.03 to 0.30.

15. The process according to claim 1, wherein the Al/Fe precipitate of the Al/Fe precipitation step is suitable for being introduced into an aluminum hydroxide production plant operated according to the Bayer process.

16. The process according to claim 2, wherein the black mass is a lithium depleted residue, whereby the lithium is extracted after the pyrolysis of the battery material.

17. The process according to claim 1, further comprising the step of reintroducing the second leaching residue to the first leaching step or to the pH adjusting step.

18. An aluminum hydroxide obtained by the process according to claim 1.

19. The process according to claim 1, wherein the black mass is a pyrolyzed lithium battery material.

20. The process according to claim 1, wherein in the first leaching step, the acid of the aqueous acid solution is sulfuric acid.
